(19) United States
(12) Patent Application Publication
(10) Pub. No.: US 2012/0031701 A1
(43) Pub. Date: Feb. 9, 2012

(54) Speed Responsive Engagement Device

(75) Inventor: Karl Jones, Wiltshire (GB)

(73) Assignee: Latchways PLC, Devizes (GB)

(21) Appl. No.: 13/123,083

(22) PCT Filed: Oct. 7, 2009
(86) PCT No.: PCT/GB09/02393

§ 371 Date: Jun. 21, 2011

(30) Foreign Application Priority Data
Oct. 7, 2008 (GB) 0818331.1

(51) Int. Cl. F16D 59/00; A62B 35/00

(52) U.S. Cl. 182/5; 188/69

(57) ABSTRACT

A speed responsive engagement device for use in a fall arrest system has a ratchet wheel having outwardly projecting spaced apart teeth and a pawl arranged for pivotal movement to engage the ratchet wheel teeth. The pawl and the ratchet wheel are rotatable relative to one another such that when relative rotation occurs between the ratchet wheel and the pawl in a first direction the pawl contacts the ratchet wheel, generating an oscillating movement of the pawl with an amplitude dependent on the speed of the rotation, and when the speed of rotation reaches a predetermined value the increased oscillating movement causes the pawl to move into the engaged orientation brakingly engaging with the ratchet wheel teeth preventing further relative rotation between the ratchet wheel and the pawl in the first direction. A biasing arrangement arranged to bias the pawl towards the disengaged orientation. A capture arrangement arranged to capture the pawl in the engaged orientation when the pawl is brakingly engaged with the ratchet wheel.

This invention relates to a speed responsive engagement device, and in particularly to a speed responsive engagement device for use in fall arrest apparatus.

Speed responsive engagement devices for use with rotating parts to selectively engage the rotating parts to other components if the speed of rotation of the parts exceeds a threshold value are well known.

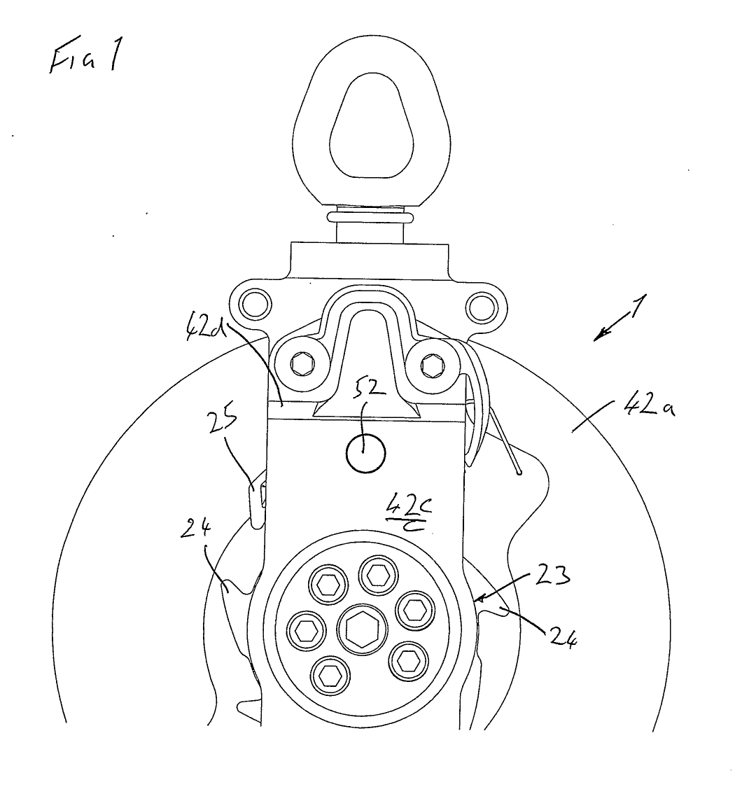

There are two main types of such speed responsive engagement devices. A first type of speed responsive engagement device is of the centrifugal clutch type. Such an arrangement is described in FIG. 1 of WO2008/007119.

A second type of speed responsive engagement device is of the rocking pawl type. An exemplary embodiment of a ratchet and pawl speed responsive engagement device is disclosed in, for example WO2008/007119.

The speed sensitive engagement means of both of these known types are used in fall arrest systems of the type where personnel working at height are attached to a safety line wound around a drum. The drum has an automatic rewinding mechanism and a speed sensitive attachment mechanism of the type disclosed above, which responds to the rotation of the drum at a speed above a predetermined threshold by holding the drum against further rotation relative to the drum support or other fixed structure.

In use, fall arrest systems of this type allow personnel to move freely around a working area including moving upwardly and downwardly in the area, with the safety line being automatically paid out from and wound onto the drum under the control of the automatic rewinding mechanism as necessary to allow the personnel movement and keep the safety line taut. When a personnel fall occurs, the safety line is pulled out at a much greater speed then is necessary for normal movement and the speed of rotation of the drum rises to the threshold value of the speed sensitive engagement means, which brakes the drum against further rotation and so arrests the fall.

In practice it has been found that there is a problem with fall arrest systems of both of these known types that after a fall has been arrested the speed sensitive engagement means can release the engagement allowing the personnel to again start to fall until the speed of rotation of the drum again reaches the threshold value and the fall is again arrested.

It has been found that it is possible for this cycle to be repeated so that personnel drop in a series of short falls until they reach the ground or some other supporting surface.

This problem is generally referred to as bounce. The problem of bounce is caused by the fact that when the known speed sensitive engagement means are in the engaged state the pawls are biased into a unengaged condition and are only kept in the engaged condition by the pawls being held against the biasing by the ratchet teeth. When these engagement means are used in a fall arrest system and a fall arrest occurs there is a stretching or tensioning of the safety line followed by a momentary reduction in tension to zero as the arrested person bounces at the end of the safety line. During this momentary reduction in tension the automatic rewinding mechanism causes the drum to rotate slightly in the rewinding direction, releasing the pawls from engagement with the ratchet teeth. The biasing then causes the pawls to move to the unengaged position, releasing the drum and allowing the personnel to start falling again.

Bounce is dangerous and presents a serious problem for a number of reasons. Firstly, the personnel may be injured by impact with other objects during the multiple falls. Further, in general fall arrest systems are designed so that users undergoing a fall arrest event are only subject to a safe level of force. However, these safe levels are calculated on the assumption of single fall event. Even when a single application of a fall arrest force is safe, repeated application of the same force to a user can result in injury. This problem is made more severe by the fact that many fall arrest systems include single use energy absorbing or shock limiting devices so that successive falls and arrests resulting from bounce may result in personnel being subject to higher than expected levels of force because the capacity of the single use energy absorbing or shock limiting devices in the system has been used up. Further, the repeated fall and arrest loads on the fall arrest system due to bounce can result in failure or damage of components of the fall arrest system or the supporting structure to which it is attached. Finally, where bounce results in personnel descending all the way to the ground or other supporting structure in a series of short falls the final impact with the ground or other support structure may be at a sufficiently high speed to cause injury. The bounce problem is addressed by the arrangement disclosed in WO2008/007119.

Control over the way in which the pawl moves from the engaged position to the disengaged position when the ratchet and pawl rotate relative to one another in the reverse direction is important in controlling the effect of bounce. In particular manufacturing tolerances of components in the arrangement can have an effect upon the circumstances of such operation. The present invention provides an arrangement in which the operation of the pawl to be held in the engagement position and caused to move from the engaged position to the disengaged position is more accurately controlled.

In accordance with the present invention, there is provided a speed responsive engagement device comprising:
a ratchet wheel having a plurality of outwardly projecting spaced apart teeth;
a pawl arranged for pivotal movement about an axis between an engagement orientation in which the pawl is orientated for braking engagement with one or more of said ratchet wheel teeth, and a disengagement orientation in which the pawl is pivoted away from the engagement orientation; the pawl and the ratchet wheel being rotatable relative to one another such that when relative rotation occurs between the ratchet wheel and the pawl in a first direction the pawl contacts the ratchet wheel, generating an oscillating movement of the pawl with an amplitude dependent on the speed of the rotation, and when the speed of rotation reaches a predetermined value the increased oscillating movement causes the pawl to move into the engaged orientation brakingly engage with the ratchet wheel teeth preventing further relative rotation between the ratchet wheel and the pawl in the first direction;
a resilient biasing arrangement arranged to bias the pawl towards the disengaged orientation; and
a capture arrangement arranged to capture the pawl in the engaged orientation when the pawl is brakingly engaged with the ratchet wheel.

In a speed sensitive engagement according to the present invention the biasing arrangement (typically a leaf spring) can be set to preferentially bias the pawls constantly to the disengaged state and therefore the tolerances for setting the biasing arrangement are greater. The capture arrangement only acts to detain the pawl in the engagement orientation when the pawl has moved by the rotational speed threshold having been reached. The pawl is only released from the capture arrangement, not by action of any biasing means, but by some other physical means such as the reverse oscillation of the pawl as relative movement occurs between the pawl and the ratchet wheel in the second direction of rotation (the rewinding direction). The pawl is not biased when in the engaged state contacting the circumferential surface and the small rotation of the drum in the rewinding direction will not be sufficient to move the pawls to the end of the circumferential surface and cause movement of the pawl from the engaged state to the unengaged state and release from the capture arrangement.

It is preferred that the pawl comprises a heel portion and the capture arrangement is arranged to hold the heel portion of the pawl captive. Beneficially, the heel portion of the pawl contacts a peripheral surface of the ratchet wheel generating the oscillating movement of the pawl as relative rotation occurs between the ratchet wheel and the pawl in a first direction. The underside of the heel portion typically rides over the peripheral surface of the ratchet wheel teeth in order to effect the oscillating motion of the pawl as relative rotation occurs.

The pawl is typically spaced from the capture arrangement in normal operation as the ratchet wheel and pawl rotate relative to one another. The pawl preferably remains free from the capture arrangement until the pawl pivots to brakingly engage the ratchet wheel.

Beneficially the pawl is arranged to be released from the capture arrangement by relative rotation of the ratchet wheel and the pawl in a second direction (rewinding direction) opposite to the first rotation direction (paying out direction).

In a preferred embodiment the pawl includes a toe portion to brakingly engage the ratchet wheel teeth and a heel portion to be held captive by the capture arrangement and wherein upon relative rotation in the second direction (rewinding direction), the toe portion of the pawl rides over the periphery of the ratchet wheel causing the heel portion of the pawl to pivot out of captive engagement with the capture arrangement.

As mentioned previously, it is preferred that, in both the engagement orientation in and the disengagement orientation, the resilient biasing arrangement acts to bias the pawl in favour of the disengaged orientation.

In a preferred embodiment the capture arrangement comprises a detent. Beneficially the detent comprises a resilient element (such as a resiliently deflectable arm) able to deflect to and from a normal orientation in order to capture the pawl. It is preferred that the resilient element is caused to deflect to capture the pawl as the pawl moves to the engagement position to brakingly engage the ratchet wheel.

In a preferred embodiment, the pawl and the detent include complementary engaging formations arranged to engage when the pawl is held captive by the capture arrangement. One of the formations may beneficially comprise a notch in the heel of the pawl.

As mentioned previously, the resilient biasing arrangement preferably comprises a spring element.

In one embodiment, adjacent ratchet wheel teeth are separated by a circumferential surface of the ratchet wheel having a substantially constant radius.

It is preferred that the capture arrangement is arranged to detain the pawl against movement in both opposed pivotal directions away from the engagement orientation.

Beneficially, the ratchet wheel teeth have an undercut surface arranged to urge the pawl into the engaged position.

It is preferred that the pawl oscillates in contact with the ratchet wheel in normal when the wheel rotates in either or both directions generating an audible sound.

Beneficially, the arrangement includes a plurality of pawls.

In a preferred realisation the invention comprises a fall arrest device comprising a speed responsive engagement device as described herein together with an elongate supporting means wound around a drum, the speed responsive engagement device being arranged to respond to rotation of the drum in a direction unwinding (paying out) the elongate support means.

Preferred embodiments of the invention will now be described by way of example only with reference to the accompanying diagrammatic figures, in which:

FIG. 1 is a schematic side view of a fall arrest safety system incorporating a speed responsive engagement device according to the invention;

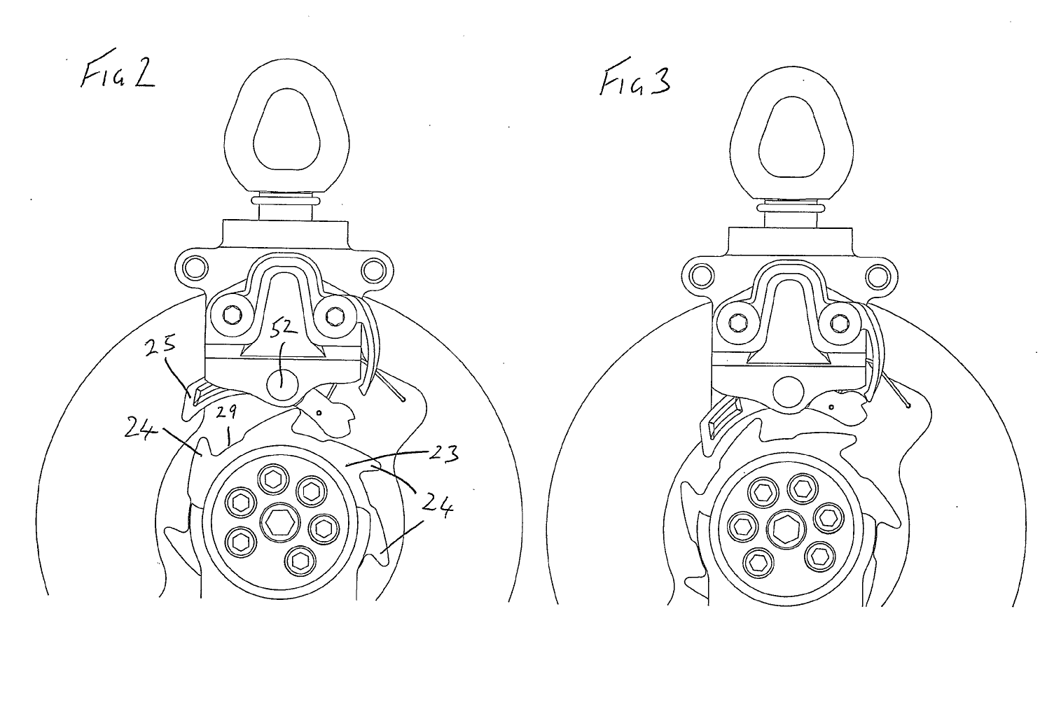

FIGS. 2 to 4 are schematic side views of the arrangement of FIG. 1 in progressive sequential orientations positions during normal unwinding (paying out) rotational orientation;

FIG. 5 is a schematic side view similar to the view of FIGS. 1 to 4 with the pawl of the speed responsive engagement device orientated to the braking engagement position with respect to the ratchet wheel;

FIGS. 6 to 8 are schematic side views of the arrangement of the preceding progressive sequential orientations positions during rewinding following the braking engagement situation as shown in FIG. 5;

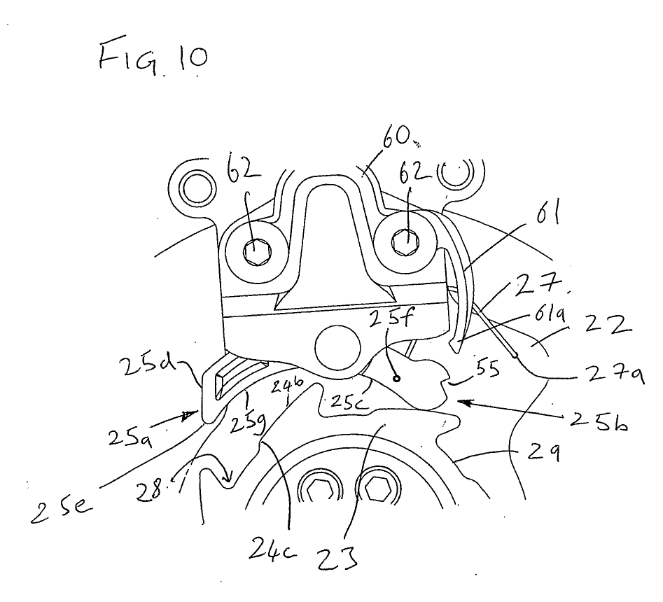

FIG. 9 is an end view of the fall arrest safety system of the preceding figures;

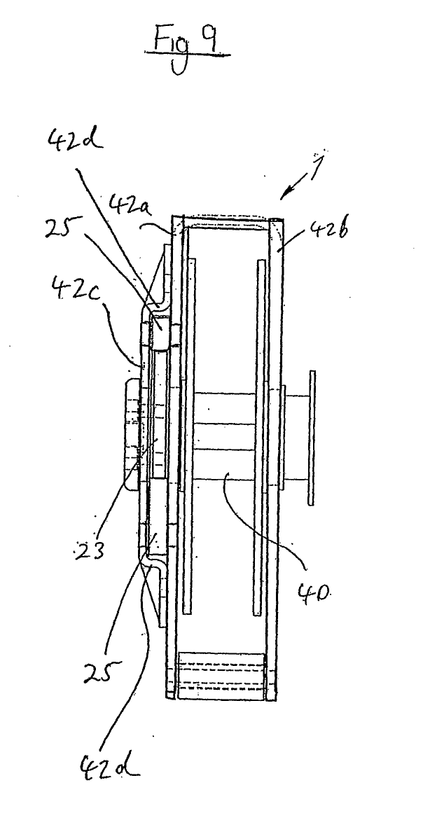

FIG. 10 is a close up view of the orientation of FIG. 8.

Referring initially to FIGS. 1, 2 and 9, a fall arrest system 1 includes a speed responsive arrangement arranged to control rotation of a drum 40 around which a safety line (not shown) is wound. The speed sensitive arrangement comprises a toothed ratchet wheel 23 (which is mounted on a shaft 21 to rotate with the drum 40) and a pair of pawls 25 which are arranged at diametrically opposed positions on either side of the ratchet wheel 23. Only one of the pawls 25 is shown in the drawings. A pair of pawls 25 is used to improve safety; the system could however function with only one pawl. The pawls 25 are each capable of independently stopping rotation of the ratchet wheel 23 and drum 40. The pawls 25 are pivotally mounted and do not rotate with the ratchet wheel 23.

The drum 40 is mounted for rotation between a pair of sideplates 42a and 42b. The speed sensitive arrangement is located between one of the sideplates 42a and a further sideplate 42c arranged parallel to the sideplate 42a and secured to the sideplate 42a by a pair of endwalls 42d. The pawls 25 are mounted on pivot bosses 52 for pivotal movement between the sideplates 42a and 42c. The mounting of the pawls 25 between the two sideplates 42a and 42c helps to stabilise the pawls 25.

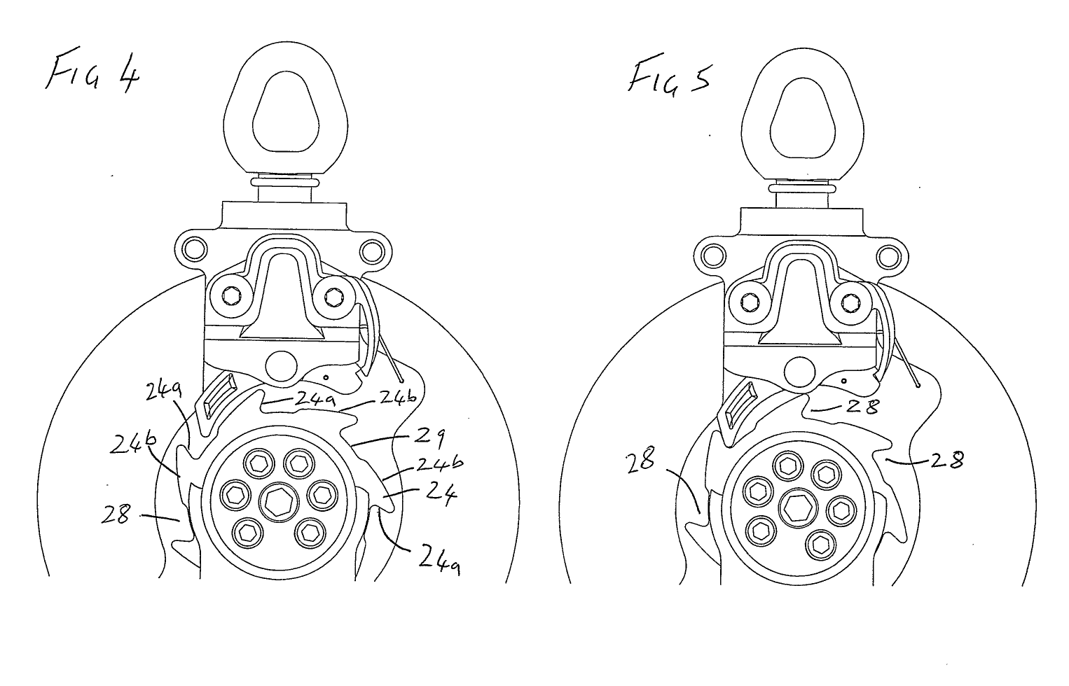

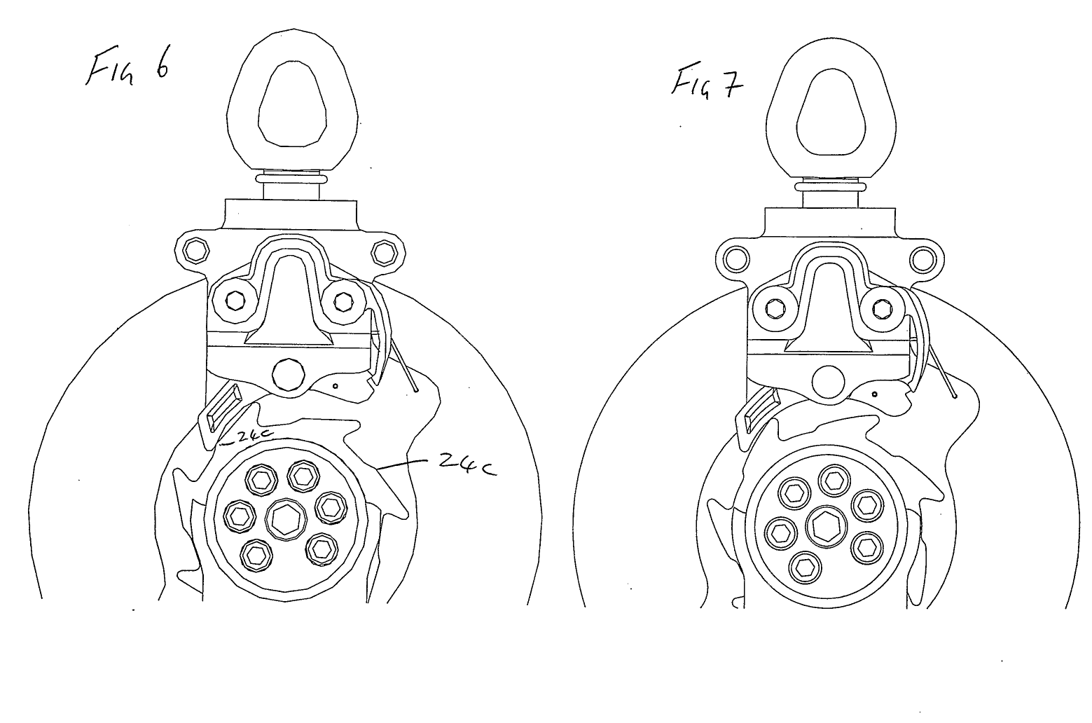

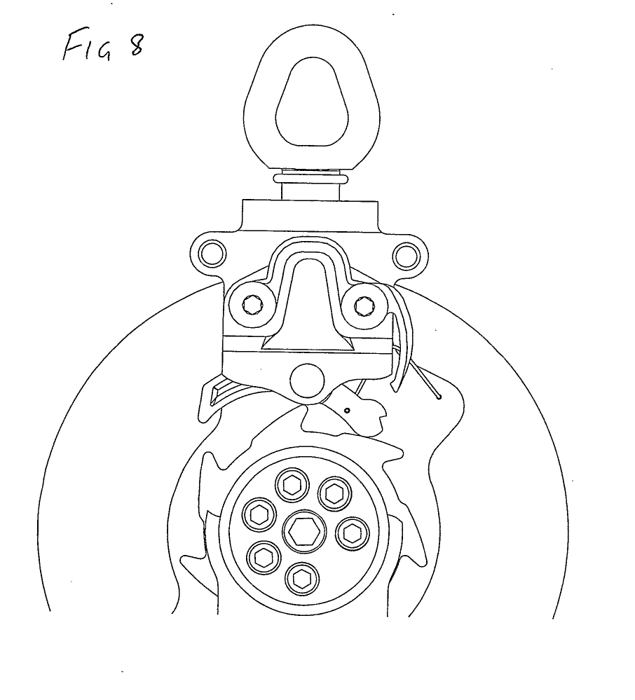

Referring to FIGS. 2 and 3, the operating parts of the speed responsive engagement arrangement according to the present invention are shown. The arrangement is responsive to the speed of rotation in a clockwise direction of the drum (and hence responsive to the speed of rotation of the shaft 21 and the ratchet wheel 23) relative to a fixed support structure of the safety apparatus (i.e. the sideplates 42a 42c).

The ratchet wheel 23 mounted on the shaft 21 comprises a circumferential surface 29 and a plurality of identical teeth 24 arranged evenly spaced around and projecting outwardly from the circumferential surface 29. Each tooth 24 has an undercut inner front sloping surface 24a and an outer rear sloping surface 24b (see FIG. 4). The teeth 24 are shaped and spaced to leave a section of the circumferential surface 29 of the wheel 23 between adjacent teeth 24. The outer rear sloping surface 24b of each tooth 24 ends in a step 24c down to the circumferential surface 29. The inner front sloping surface 24a of each tooth 24 is arranged to define a recess 28 between the front surface 24a and the circumferential surface 29 of the wheel 23.

The pawl 25 is mounted for pivotal movement about an axis on pivot boss 52 on the supporting structure adjacent to the ratchet wheel 23. The pawl 25 can move in a first oscillating regime in a disengaged manner, shown in FIGS. 1 to 4, in which the ratchet wheel 23 and shaft 21 are able rotate relative to the fixed structure 22. As will be described later rotation of the shaft and drum above a predetermined threshold speed causes the pawl to pivot to an extreme pivoted orientation (engagement orientation) in which the toe of the pawl brakingly engages with the ratchet wheel 23 so that rotation of the ratchet wheel 23 and shaft 21 relative to the support structure 22 (and pawl 25) in a clockwise direction is prevented. This is the braking engagement orientation as shown in FIG. 5.

The engagement between the pawl 25 and ratchet wheel 23 only prevents rotation of the shaft 21 in one direction, clockwise in the figures. Similarly to the prior art devices rotation of the shaft 21 in the opposite direction, anticlockwise in the illustrated embodiment, releases the engagement between pawl 25 and ratchet wheel 23. The speed responsive engagement device according to the present invention could be made opposite handed to be responsive to rotation in an anticlockwise direction.

The pawl 25 (as most clearly shown in FIG. 10) is arranged for pivoting movement around the axis of pivot formation 52 and has a toe end 25a and a heel end 25b arranged on opposite sides of the pivot axis. The toe end 25a of the pawl 25 is shaped to be able to engage with a tooth 24 of the ratchet wheel 23 when the pawl 25 is in the braking engaged position, as shown in FIG. 5. The lower side of the pawl between the toe and the heel 25b has a smoothly curved concave inner surface 25c so that when the pawl 25 is in the disengaged position shown in FIGS. 1 to 4 and the ratchet wheel 23 rotates in a clockwise direction underside of the pawl is contacted by a tip of each tooth 24 of the ratchet wheel 23 so that as the ratchet wheel 23 rotates the second end 25b of the pawl 25 is urged outwardly.

Also as shown most clearly in FIG. 10, a leafspring 27 connects a point 27a on the fixed structure 22 to a point 25f on the pawl 25. The leafspring 27 is held in compression so that it permanently preferentially urges the pawl 25 to rotate clockwise towards the disengaged position shown in FIG. 10. The clockwise rotation of the pawl 25 driven by the leafspring 27 is limited by the heel 25b of the pawl 25 contacting a tooth 24 of the ratchet wheel 23. The heel 25b is provided with a v shaped notch 55, the purpose of which is explained later.

Accordingly, when the shaft 21 and the attached ratchet wheel 23 rotates clockwise under normal operation, each tooth 24 of the ratchet wheel 23 in turn contacts the heel 25b of the pawl 25 and urges the heel 25b of the pawl 25 outward against the bias of the leaf spring 27. As a result, the pawl 25 follows an oscillating movement as shown in FIGS. 1 to 4.

The higher the speed of relative rotation of the shaft 21 and ratchet wheel 23, the greater the amplitude of the oscillation of the pawl 25 will be. When the speed of clockwise rotation of the shaft 21 and ratchet wheel 23 rises to a threshold speed the amplitude of the oscillation of the pawl 25 will be sufficient to pivot the pawl 25 to its extreme position, to bring the toe end 25a of the pawl 25 into contact with a tooth 24 of the ratchet wheel 23. The braking engagement position as shown in FIG. 5.

When the pawl 25 is in the disengaged position and the ratchet wheel 23 rotates anticlockwise (rewinding in the line on the drum 40) the heel 25b of the pawl 25 is contacted by the outer surface of each tooth 24 of the ratchet wheel 23 so that as the ratchet wheel 23 rotates the heel 25b of the pawl 25 is urged outward against the bias of the leaf spring 27. As a result, the pawl 25 follows an oscillating movement out of the unengaged position shown in FIG. 3 towards the engaged position shown in FIG. 4 and then back to the unengaged position shown in FIG. 3. The toe end 25a of the pawl 25 has a smoothly curved concave inner surface 25g.

As explained above, rotation of the shaft 21 and ratchet wheel 23 in either direction causes contact of each tooth 24 in turn with the pawl 25. These contacts produce a clicking sound which provides an audible indication of proper operation of the engagement device 20 to a user.

The toe end 25a of the pawl 25 has an outer end surface 25d shaped to cooperate with the front surface 24a of the tooth 24 so that when the end outer end surface 25d contacts front surface 24a of a tooth 24 the first end 25a of the pawl 24 is urged into the recess 28. As a result, when the speed of rotation of the shaft 21 and ratchet wheel 23 rises to the threshold value the pawl 25 will be pivoted into the engaged position shown in FIG. 5 where a tip 25e of the first end 25a of the pawl 25 is inserted as far as possible into the recess 28 and contacts the front surface 24a of the tooth 24 and the circumferential surface 29 of the wheel 23, which extends between the teeth 24. This engagement will brake the ratchet wheel 23 against the pawl 25 and stop further clockwise rotation of the shaft 21 and ratchet wheel 23 relative to the fixed structure 22.

As this reorientation of the pawl 25 to the engaged position occurs, the heel 25b of the pawl is captured by a capture arrangement 60 comprising a resiliently flexible detent arm 61. The capture arrangement is fixed to the structure plate 42d by means of fasteners 62, and the detent arm 61 extends from a fixed end to a free end 61a which is provided with a male formation for engagement in the v shaped notch formed in the heel 25b of the pawl 25. The detent arm flexes as the heel 25b passes by the free end of the arm. Then the heel is captured by the capture arrangement as shown in FIG. 5, the leaf spring 27 still acts to promote reorientation of the pawl 25 to the disengaged position but movement of the pawl to revert to the disengaged position is prevented by engagement with the tooth recess 28 and also the location of the detent arm 61 of the capture arrangement 60.

If bounce occurs (or when the line is deliberately re wound) causing movement of the ratchet wheel in the anticlockwise direction, the tip 25e of the pawl toe end 25a rides along the constant radius surface until the step formation 24c is reached. Up until this point the pawl remains in the engagement orientation even though the tip 25e of the toe end 25a of the pawl 25 is no longer located fast in the tooth recess 28. This is because the heel end 25b of the pawl 25 remains held captive by the detent of the capture device. During bounce, this degree of anticlockwise rotation is not surpassed and therefore during a fall event, once the pawl is pivoted to the engagement orientation to engage the teeth, it is not subsequently moved back to the disengaged position.

In other situations where for example the pawl 25 is pivoted to the engaged situation, then allowing the line to be rewound (in the anticlockwise direction of rotation of the ratchet wheel) causes the tip 25g of the toe end 25a of the pawl 25 to reach the step 25c (FIG. 6) and then pass up along the outer surface 24b of a tooth 24 (FIG. 7). In so doing the pawl is caused to pivot about the pivot formation 45 and the heel 25b of the pawl is released from being held captive by the detent arm 61 of the capture arrangement. The pawl is then urged back to the disengagement orientation by the leaf spring 27 (FIG. 8).

The surface profile of the ratchet wheel between adjacent teeth 24 sets a threshold amount of counter rotation (anticlockwise in the embodiment) required to disengage the pawl 23 from a tooth 24. Counter rotation by less than this threshold amount will not disengage the pawl 23 from a tooth 24. The counter rotation causes the pawl to be pivoted by reaction against the ratchet wheel to be released from the capture arrangement. The constant biasing to restore the pawl to the disengaged position is free to act to move the pawl 25 once the pawl has been released from the capture arrangement 60.

As a result, when the speed responsive engagement device 20 of the present invention is used in a fall arrest system, if a fall causes a safety line to be unwound from a drum at or above the threshold speed the pawl 25 will engage with a tooth 24 of the wheel 23, stopping the rotation of the drum and arresting the fall. If the tension in the safety line then temporarily drops to a low value or zero because of the arrested person bouncing on the end of the safety line, or other transient effects, the resulting small anticlockwise rotation of the wheel 23 produced by the automatic rewinding mechanism will not disengage the pawl 23 from the tooth 24 and allow the person to resume their fall. Accordingly, the problem of bounce is overcome.

In the descriptions of the preferred embodiment set out above the use of a safety line wound around the drum is referred to. This is not essential and other forms of elongate support such as a cable or a webbing strap could be used instead.

In the embodiment described, the ratchet wheel is rotatable with respect to the support surface 22 and side plates 42a, 42c. In an alternative embodiment the ratchet wheel could be fixed and the pawls 25 mounted for rotation with the drum 40.

The above description refers to fall arrest systems for arresting a fall by a user. This is the most common application of a fall arrest system. However, the present invention can also be used in a height safety system to arrest falls by objects, for example, equipment being used or moved at height.

The embodiments discussed above are examples only and are not exhaustive. The skilled person will be able to envisage further alternatives within the scope of the present invention as defined by the attached claims.

1. A speed responsive engagement device comprising:
a ratchet wheel having a plurality of outwardly projecting spaced apart teeth;
a pawl arranged for pivotal movement about an axis between an engagement orientation in which the pawl is orientated for braking engagement with one of said ratchet wheel teeth, and a disengagement orientation in which the pawl is pivoted away from the engagement orientation; the pawl and the ratchet wheel being rotatable relative to one another such that when relative rotation occurs between the ratchet wheel and the pawl in a first direction the pawl contacts the ratchet wheel, generating an oscillating movement of the pawl with an amplitude dependent on the speed of the rotation, and when the speed of rotation reaches a predetermined value the increased oscillating movement causes the pawl to move into the engaged orientation brakingly engaging with the ratchet wheel teeth preventing further relative rotation between the ratchet wheel and the pawl in the first direction;
a resilient biasing arrangement arranged to bias the pawl towards the disengaged orientation; and
a capture arrangement arranged to capture the pawl in the engaged orientation when the pawl is brakingly engaged with the ratchet wheel.

2. A speed responsive engagement device according to claim 1, wherein the pawl comprises a heel portion and the capture arrangement is arranged to hold the heel portion of the pawl captive.

3. A speed responsive engagement device according to claim 2 wherein the heel portion of the pawl contacts a peripheral surface ratchet wheel generating the oscillating movement of the pawl as relative rotation occurs between the ratchet wheel and the pawl in a first direction.

4. A speed responsive engagement device according to claim 1, wherein the pawl is free from the capture arrangement until the pawl is reorientated to pivot to brakingly engage the ratchet wheel.

5. A speed responsive engagement device according to claim 1, wherein the pawl is arranged to be released from the capture arrangement by relative rotation of the ratchet wheel and the pawl in a second direction opposite to the first rotation direction.

6. A speed responsive engagement device according to claim 5, wherein the pawl includes a toe portion to brakingly engage the ratchet wheel and a heel portion to be held captive by the capture arrangement and wherein upon relative rotation in the second direction, the toe portion of the pawl rides over the ratchet wheel causing the heel portion of the pawl to pivot out of captive engagement with the capture arrangement.

7. A speed responsive engagement device according to claim L wherein in both the engagement orientation in and the disengagement orientation, the resilient biasing arrangement acts to bias the pawl in favor of the disengaged orientation.

8. A speed responsive engagement device according to claim 1, wherein the capture arrangement comprises a detent.

9. A speed responsive engagement device according to claim 8, wherein the detent comprises a resilient element able to deflect to and from a normal orientation in order to capture the pawl.

10. A speed responsive engagement device according to claim 9 wherein the resilient element is caused to deflect to capture the pawl as the pawl moves to the engagement position to brakingly engage the ratchet wheel.

11. A speed responsive engagement device according to claim 8, wherein the pawl and the detent include complementary engaging formations arranged to engage when the pawl is held captive by the capture arrangement.

12. A speed responsive engagement device according to claim 11, wherein one of the formations comprises a notch in the heel of the pawl.

13. A speed responsive engagement device according to claim 1, wherein the resilient biasing arrangement comprises a spring element.

14. A speed responsive engagement device according to claim 1, wherein adjacent ratchet wheel teeth are separated by a circumferential surface of the ratchet wheel having a substantially constant radius.

15. A speed responsive engagement device according to claim 1, wherein the capture arrangement is arranged to detain the pawl against movement in both opposed pivotal directions away from the engagement orientation.

16. A speed responsive engagement device according to claim 1, wherein the ratchet wheel teeth have an undercut surface arranged to urge the pawl into the engaged position.

17. A speed responsive engagement device according to claim 1, in which when the wheel rotates in either direction each tooth in turn contacts the pawl generating an audible sound.

18. A speed responsive engagement device according to claim 1, and comprising a plurality of pawls.

19. A fall arrest device comprising a speed responsive engagement device according to claim 1 together with an elongate supporting means wound around a drum, the speed responsive engagement device being arranged to respond to rotation of the drum in a direction unwinding the elongate support means.
